(19) United States
(12) Patent Application Publication
(10) Pub. No.: US 2021/0291193 A1
(43) Pub. Date: Sep. 23, 2021

(54) MANUALLY ASSSISTED POWERED GRINDING OF GRAINS

(71) Applicant: Yaakov SCHWARTZ, Beit Shemesh (IL)

(72) Inventor: Yaakov SCHWARTZ, Beit Shemesh (IL)

(21) Appl. No.: 16/820,957

(22) Filed: Mar. 17, 2020

(51) Int. Cl. B02C 7/18; F03G 3/00

(52) U.S. Cl. CPC B02C 7/188; F03G 3/00; B02C 7/186

(57) ABSTRACT

The present invention provides systems and methods for production using manual labor. The present invention involves the transition of energies to perform labor. The transition involves manual labor energy turning into kinetic energy and further transition of the kinetic energy into mechanical or electrical energy used for performing designated labor.

### TECHNICAL FIELD

The present invention is directed to systems and methods for production using manual labor.

### BACKGROUND OF THE INVENTION

Jewish halakha is a collective body of Jewish religious laws derived from the written and Oral Torah. Halakha is based on biblical commandments (mitzvot), subsequent Talmudic and rabbinic law, and the customs and traditions compiled in the many books such as the Shulchan Aruch.

In Jewish halakha, many commandments require that the commandment be performed manually with preference that the action taken place will be for the sole purpose of making the commandment, for example, while grinding wheat for matzoth, making tefillin, making tzitzit, etc.

Manually performed commandments tend to be time-consuming and involve hard laboring due to the need to avoid any machine assistance.

### SUMMARY OF THE INVENTION

The present invention provides systems and methods for production using manual labor. Embodiments of the invention are directed to a method for grinding agricultural particulates comprising: dropping an object along a predetermined pathway from a first position to a second position so as to turn a wheel at the second position; turning a grinding element in communication with the wheel in response to the turn of the wheel so as to grind the agricultural particulates; and, moving the object to the first position for it to be reused.

Optionally, the method is such that the object is a weight.

Optionally, the method is such that the grinding element is a millstone.

Optionally, the method is such that the predetermined pathway includes a belt conveyer.

Optionally, the method is such that the predetermined pathway includes a tube.

Embodiments of the invention are directed to a method for utilizing manual labor comprising: dropping an object along a predetermined pathway from a first position to a second position so as to turn a wheel at the second position, the turn of the wheel generates kinetic energy; converting the kinetic energy into electric energy using a converter; and, moving the object to the first position for it to be reused.

Optionally, the method is such that the object is a weight.

Optionally, the method is such that the predetermined pathway includes a belt conveyer.

Optionally, the method is such that the predetermined pathway includes a tube.

Optionally, the method is such that the converter is a generator.

Embodiments of the invention are directed to a system for grinding agricultural particulates comprising: a platform; a transporting element extending at least partially along the platform, the transporting element configured to move an object towards a wheel at the end of the transporting element so as to turn the wheel; a grinding element in communication with the wheel configured for grinding the agricultural particulates in response to the turn of the wheel;

Optionally, the system is such that it additionally comprises: a tube configured to receive the object after the turn of the wheel; and, a second transporting element extending at least partially along the other side of the platform, the second transporting element configured to receive the object from the tube so as to move the object to the platform to be reused.

Optionally, the system is such that the transporting element is a belt conveyor including a plurality of movable portions configured for receiving the object.

Optionally, the system is such that the object is a weight.

Optionally, the system is such that the grinding element is a millstone.

Optionally, the system is such that the agricultural particulates are one of seeds, beans and a combination thereof.

Unless otherwise defined herein, all technical and/or scientific terms used herein have the same meaning as commonly understood by one of ordinary skill in the art to which the invention pertains. Although methods and materials similar or equivalent to those described herein may be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE DRAWINGS

Some embodiments of the present invention are herein described, by way of example only, with reference to the accompanying drawings. With specific reference to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

Attention is now directed to the drawings, where like reference numerals or characters indicate corresponding or like components. In the drawings:

FIG. 1 is a perspective view of a system according to an embodiment of the present invention;

FIG. 2 is a perspective view of the system according to another embodiment of the present invention;

### DETAILED DESCRIPTION OF THE DRAWINGS

The present invention is not limited in its application to the details of construction and the arrangement of the components set forth in the following description. The invention is capable of other embodiments, or of being practiced or carried out in various ways. Also, it is to be understood that the phraseology and terminology employed herein is for the purpose of description and should not be regarded as limiting.

Throughout this document, references to directions and orientations, such as, lower, upper, and the like, are made. These references are exemplary, for describing and explaining the present invention, and embodiments thereof, and are not limiting in any way.

The present invention provides systems and methods for production using manual labor. The present invention involves transitioning manual labor energy into kinetic energy and the further transitioning of the kinetic energy into mechanical energy to perform labor.

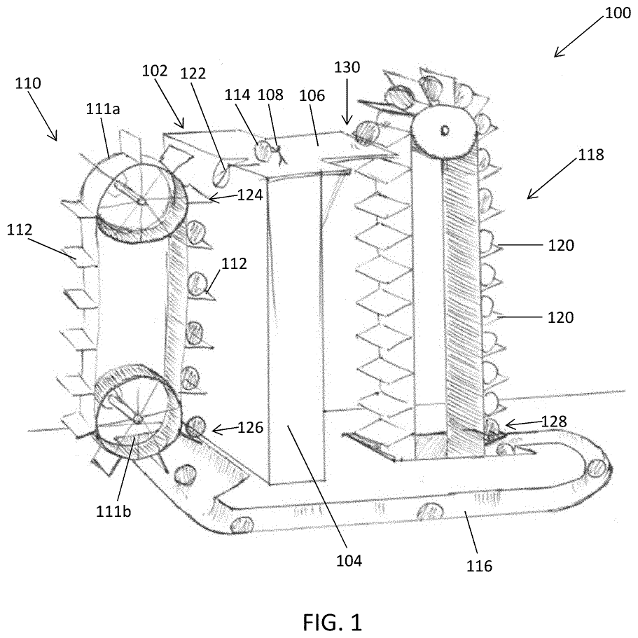

FIG. 1 is a perspective view of the system 100. The system 100 includes a platform 102 having a scaffold 104 and a surface 106 on which a subject 108 is standing. The system 100 further includes a first belt conveyer 110, extending at least partially along the platform 102, having a first wheel 111a, a second wheel 111b, and a plurality of movable portions 112 configured for receiving an object 114, for example, a weight. The belt conveyor 110 is connected, for example, to a grinding element (not shown) e.g. a millstone configured for grinding agricultural particulates, such as seeds, beans, and the like.

The belt conveyor 110 is further connected to a tube or channel 116. The tube or channel 116 is linked to a second belt conveyor 118 having a plurality of movable portions 120 configured for receiving the object 114. The second belt conveyor 118 is operated, for example, automatically.

In operation, the subject 108 drops the object 114 from the surface 106 through, for example, slop 122. The object 114 is dropped onto one of movable portions 112 causing the belt conveyer 110 to turn and move the object 114 from a first higher position 124 to a second lower position 126. The turning of belt conveyor 110 by the drop of object 114 generates kinetic energy. This kinetic energy is then converted into mechanical energy by causing the grinding element (not shown) to rotate and grind the agricultural particulates positioned below it. The rotation of the grinding element is achieved by an interaction, either directly or indirectly, between the second wheel 111b and the mechanical element.

As the object 114 reaches the second lower position 126, the object 114 is released into the tube or channel 116. The tube or channel 116 which is positioned, for example, in slop moves the object 114 towards the second belt conveyor 118.

Once at the second belt conveyor 118, the object 114 is lifted by one of movable portions 120 from a first lower position 128 to a second higher position 130 to be reused.

In another embodiment, the wheel 111b can be further rotated using a handle (not shown) positioned on it, so as to cause further movement of the wheel 111b and the first belt conveyer 110.

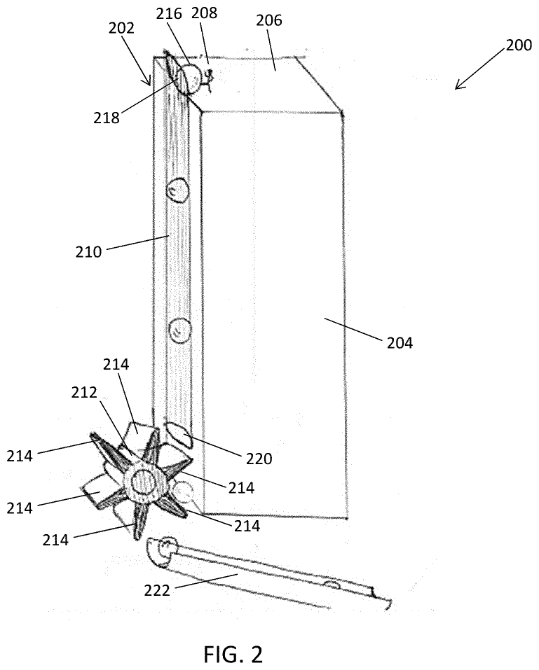

FIG. 2 is a perspective view of the system 200. The system 200 includes a platform 202 having a scaffold 204 and a surface 206 on which a subject 208 is standing. The system 200 further includes a tube or pipe 210 extending at least partially along the platform 202 and a wheel 212 having protrusions 214 configured for receiving an object 216. The tube or pipe 210 includes a proximal end 218 and a distal end 220.

The wheel 212 is connected to a grinding element (not shown), for example, a millstone configured for grinding agricultural particulates, such as seeds, beans, and the like.

The wheel 212 is further connected to a tube or channel 222 linked to a manually or mechanically operated system (not shown) configured to receive the object 216 from the tube or channel 222.

In operation, the subject 208 drops the object 216 into the tube or pipe 210 through, for example, the proximal end 218. The object 216 is then dropped via free fall from the proximal end 218 to the distal end 220. Once at the distal end 220, the object 216 is received by one of protrusions 214, an action that causes the wheel 212 to turn. The drop of object 216 using the subject 208 manual labor generates kinetic energy that is then converted to mechanical energy once the object 216 turns the wheel 212. The wheel 212 rotates the grinding element (not shown) connected to it, either directly or indirectly, and the grinding element grinds the agricultural particulates positioned below it.

After the object 216 causes the wheel 212 to rotate, the object 216 is released to the tube or channel 222. The tube or channel 222 which is positioned, for example, in slop moves the object 216 towards the manually or mechanically operated system (not shown). Once at the manually or mechanically operated system (not shown), the object 216 is lifted back onto the platform 202 to be reused.

In another embodiment, systems 100 and 200 include, for example, a generator connected to the second wheel 111b or the wheel 212 respectively, either directly or indirectly. The generator is used for generating electrical energy by converting the kinetic energy generated by the object 114/216. The electrical energy generated by the generator can then be instantly utilized or stored for later use in, for example, a battery.

While the invention has been described with respect to a limited number of embodiments, it will be appreciated that many variations, modifications and other applications of the invention may be made. Therefore, the claimed invention as recited in the claims that follow is not limited to the embodiments described herein.

1. A method for grinding agricultural particulates comprising:
manually moving an object from a surface of a platform and causing it to drop along a predetermined pathway from a first position to a second position, lower than the first position, so as to turn a wheel;
letting a grinding element, in communication with said wheel, turn in response to the turning of said wheel so as to grind the agricultural particulates.

2. The method of claim 1, wherein said object is a weight.

3. The method of claim 1, wherein said grinding element is a millstone.

4. The method of claim 1, wherein said predetermined pathway includes first a belt conveyor.

5. The method of claim 1, wherein said predetermined pathway includes a tube, through which said object drops, and said wheel has protrusions configured to receive said object when dropped through said tube.

6. (canceled)

7. (canceled)

8. (canceled)

9. (canceled)

10. (canceled)

11. A system for grinding agricultural particulates comprising:
a platform, including a surface;
one or more objects, having weight, said platform being configured to have the objects rest on said surface or proximate thereto;
a transporting element extending vertically at least partially along said platform, and configured to let one or more of said objects move down along it;
a wheel connected to said transporting element so as to be turned by said down motion of the objects; and
a grinding element in communication with said wheel configured for grinding the agricultural particulates in response to the turning of said wheel;
wherein said platform and said transporting element are further configured so that a subject may stand on the surface and manually cause one or more of the objects to be dropped onto the transporting element.

12. The system of claim 11, additionally comprising:
a tube or channel, configured to receive each of the objects after said down motion; and
a second transporting element extending vertically at least partially along said platform, and configured to receive said objects from said tube or channel and to raise them to the surface of said platform or proximate thereto.

13. The system of claim 11, wherein said transporting element is a belt conveyor including a plurality of movable portions, each configured to receive, and be move by, one or more of said objects.

14. The system of claim 11, wherein said object is a weight.

15. The system of claim 11, wherein said grinding element is a millstone.

16. The system of claim 11, wherein said agricultural particulates are one of seeds, beans and a combination thereof.

17. The method of claim 1, wherein said moving is by a subject standing on said platform.

18. The method of claim 1, further comprising letting said object, after reaching the second position, be moved back to said surface so as to be ready to be manually moved.

19. The method of claim 18, wherein said moving back is by means of a tube or channel and a second belt conveyer.

20. The method of claim 19, wherein operation of the second belt conveyer is automatic.

21. The method of claim 1, wherein said communication includes an electric generator.

22. The system of claim 11, wherein said transporting element includes a tube or pipe and said wheel has protrusions configured to receive, and be moved by, said objects when dropped through said tube or pipe.
